(19) United States
(12) Patent Application Publication
(10) Pub. No.: US 2012/0095796 A1
(43) Pub. Date: Apr. 19, 2012

(54) SYSTEM AND METHOD FOR MOBILE SURVEY MANAGEMENT

(75) Inventors: Charles A. Gately, Arlington, VA (US); Sunil K. Pasi, Arlington, VA (US); Walter G. Lukens, III, Arlington, VA (US)

(73) Assignee: E Motive LLC, Arlington, VA (US)

(21) Appl. No.: 13/098,077

(22) Filed: Apr. 29, 2011

Related U.S. Application Data
(60) Provisional application No. 61/329,281, filed on Apr. 29, 2010.

(51) Int. Cl. G06Q 10/06

(52) U.S. Cl. 705/7.13

(57) ABSTRACT

A method for mobile survey management includes creating a survey database for storing surveyee information, survey question information, survey results information, the surveyee information including a list of a plurality of surveyees to be visited by a plurality of surveyors, and the survey question information including a survey question to ask to the plurality of surveyees, assigning one or more surveyors to one or more surveyees, transmitting the surveyee information including the list of one or more surveyees assigned to each surveyor to each surveyor's mobile survey device along with the survey question information, displaying the list of the one or more surveyees assigned to each surveyor on each surveyor's mobile survey device, displaying the survey question on the display of each surveyor's mobile survey device, entering an answer by each surveyee to the survey question to the mobile survey device, transmitting the survey result from each mobile survey device to the database, the survey result comprising the answer by each surveyee to the survey question, and updating the survey results information in the survey database based on the survey results transmitted from the plurality of mobile survey devices in a real-time basis.

### CROSS REFERENCE TO PRIOR APPLICATIONS

This application claims the benefit from U.S. Provisional Application No. 61/329,281 filed on Apr. 29, 2010, which is hereby incorporated by reference for all purposes as if fully set forth herein.

### BACKGROUND OF THE DISCLOSURE

1. Field of the Disclosure

This disclosure is directed to mobile survey management, and particularly to a system and method for mobile survey management.

2. Related Art

Statistical surveys depend on surveyee's motivation, honesty, memory, and ability to respond. Surveyees are very often unaware of their reasons for any given action and may not be motivated to give accurate answers. These problems become even worse when a survey is conducted by phone, mail, over the Internet or email because there is no real human interact. Thus, surveyors rely on door to door in person visits in order to acquire more accurate answers. However, it is often very difficult to hire surveyors for any reasonable size surveying because it is hard to monitor whether each surveyor is actually visiting the surveyee to ask questions. Also, once the surveyors are dispatch with survey questions, it is difficult to modify the survey questions. Accordingly, there is a need for an improved survey management system.

### SUMMARY OF THE DISCLOSURE

According to an aspect of the disclosure, a method for mobile survey management includes creating a survey database for storing surveyee information, survey question information, survey results information, the surveyee information including a list of a plurality of surveyees to be visited by a plurality of surveyors, and the survey question information including a survey question to ask to the plurality of surveyees, assigning one or more surveyors to one or more surveyees, transmitting the surveyee information including the list of one or more surveyees assigned to each surveyor to each Surveyor's mobile survey device along with the survey question information, displaying the list of the one or more surveyees assigned to each surveyor on each surveyor's mobile survey device, displaying the survey question on the display of each surveyor's mobile survey device, entering an answer by each surveyee to the survey question to the mobile survey device, transmitting the survey result from each mobile survey device to the database, the survey result comprising the answer by each surveyee to the survey question, and updating the survey results information in the survey database based on the survey results transmitted from the plurality of mobile survey devices in a real-time basis.

The plurality of surveyees may include at least one of a plurality of addresses, a plurality of people and a plurality of entities. The surveyee information further may further include at least one of a person's age, sex, race, voting registration date, registered party, phone number and special notes. The one or more surveyees in the list assigned to each surveyor may be located in the same geographical area.

The survey database may store surveyor information in the data storage, the surveyor information including a list of the plurality of surveyors. The surveyor information may further include at least one of login information, a name, an email address and a phone number of each surveyor.

The method may further include modifying the survey question stored in the survey database, transmitting the modified survey question to the plurality of mobile survey devices, and replacing the survey question in each mobile survey device with the modified survey question on the display of each mobile survey device.

The method may further include displaying a map showing locations of the one or more surveyees assigned to each surveyor on a display of each surveyor's mobile survey device. The method may further include displaying whether or not each surveyee's in the list answered the survey question. The method may further include displaying each surveyor's progress in surveying the one or more surveyees in the list assigned each surveyor,

According to another aspect of the disclosure, a system for mobile survey management includes a data center including a survey database for storing surveyee information, survey question information, survey results information, the surveyee information including a list of a plurality of surveyees to be visited by a plurality of surveyors, and the survey question information including a survey question to ask to the plurality of surveyees, and a plurality of mobile survey devices connected to the data center via one or more communication channels and carried by the plurality of surveyors, respectively. Each mobile survey device including a communication unit configured to receive the surveyee information including a list of one or more surveyees assigned to each surveyor along with the survey question information from the data center, a display configured to display the list of the one or more surveyees assigned to each surveyor and the survey question information, and a user interface configured to enter an answer by each surveyee to the survey question. The communication unit transmits each surveyees answer to the survey question to the data center, and the survey results information in the survey database is updated based on each surveyee's answer transmitted from each mobile service device.

Each mobile survey device may be one of a mobile phone, a mobile computer, a mobile tablet computer. Each mobile survey device may be a mobile phone operated by one of an Apple™ iOS™ operating system, a Google™ Android™ operating system, a RIM™ Blackberry™ operating system, a Nokia™ Syrnbian™ operating system, a Microsoft™ Windows Mobile™ operating system, a Microsoft™ Windows Phone™ operating system and a Linux™ operating system.

The mobile survey device may be further configured to display a map showing locations of the one or more surveyees in the assigned list on the display thereof. The mobile survey device may be further configured to display whether or not each surveyees in the assigned list has answered to the survey question on the display thereof in a real-time basis. The one or more surveyees in the list assigned to each surveyor may be located in the same geographical area.

The plurality of surveyees may include at least one of a plurality of addresses, a plurality of people and a plurality of entities. The survey database may further store surveyor information including a list of a plurality of surveyors, the surveyor information may further including at least one of each surveyor's login information, name, email address and phone number.

The system may further include a management computer connected to the data center via the one or more communication channels to access the survey database. The management computer may be configured to change the surveyee information and the survey question information and access the survey results information.

Additional features, advantages, and embodiments of the disclosure may be set forth or apparent from consideration of the following detailed description, drawings, and claims. Moreover, it is to be understood that both the foregoing summary of the disclosure and the following detailed description are exemplary and intended to provide further explanation without limiting the scope of the disclosure as claimed.

### BRIEF DESCRIPTION OF THE DRAWINGS

The accompanying drawings, which are included to provide a further understanding of the disclosure, are incorporated in and constitute a part of this specification, illustrate embodiments of the disclosure and together with the detailed description serve to explain the principles of the disclosure. No attempt is made to show structural details of the disclosure in more detail than may be necessary for a fundamental understanding of the disclosure and the various ways in which it may be practiced. In the drawings:

FIG. 1 shows a conceptual overview of a system for mobile survey management constructed according to the principles of the disclosure.

FIG. 2 shows a flowchart of a process for mobile survey management according to the principles of the disclosure.

FIG. 3 shows a flowchart of a process for operating a mobile survey device according to the principles of the disclosure.

FIGS. 4A, 4B, 4C, 4D, 4E, 4F, 4G, 4H, 4I, 4J and 4K show various screen capture images of webpages of a mobile survey management website constructed according to the principles of the disclosure.

FIGS. 5A, 5B, 5C, 5D and 5E show various screen capture image of a mobile survey device constructed according to the principles of the disclosure.

### DETAILED DESCRIPTION OF THE DISCLOSURE

The embodiments of the disclosure and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the disclosure. The examples used herein are intended merely to facilitate an understanding of ways in which the disclosure may be practiced and to further enable those of skill in the art to practice the embodiments of the disclosure. Accordingly, the examples and embodiments herein should not be construed as limiting the scope of the disclosure, which is defined solely by the appended claims and applicable law. Moreover, it is noted that like reference numerals represent similar parts throughout the several views of the drawings.

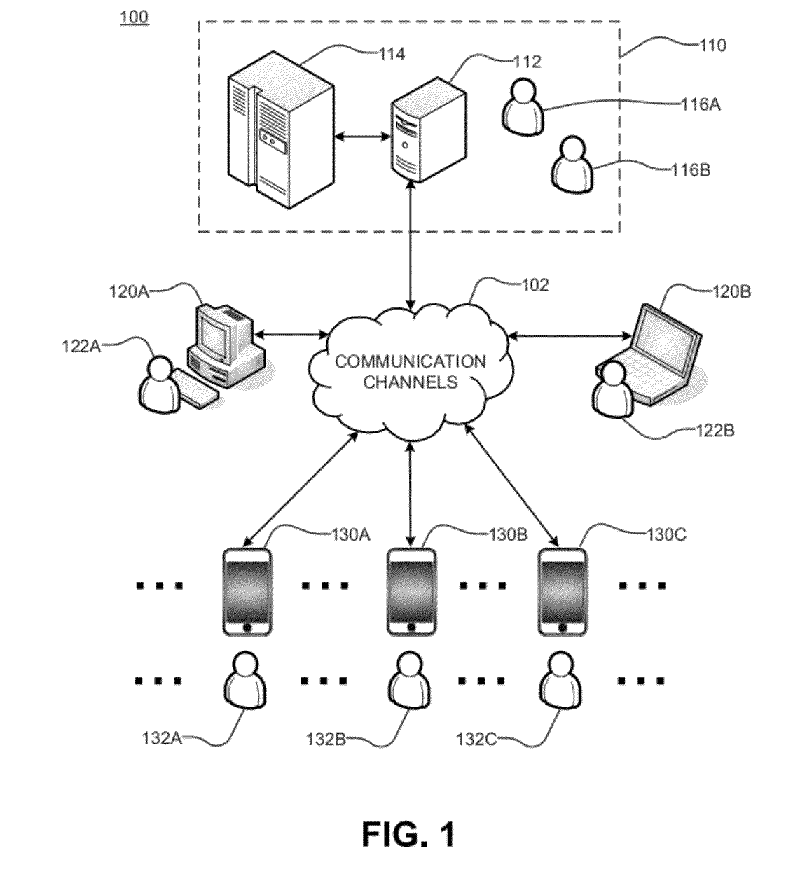

FIG. 1 shows a conceptual overview of a system 100 for mobile survey management constructed according to the principles of the disclosure. The system 100 may include a data center 110, one or more management computers 120 (e.g., management computers 120A, 120B and/or the like), a plurality of mobile survey devices 130 (e.g., mobile survey devices 130A, 130B, 130C and/or the like) and/or the like, that may be connected to each other via one or more communication channels 102. In other words, the system 100 may be a network of a plurality of data communication devices including the data center 110, the one or more management computers 120, the plurality of mobile survey devices 130 and/or the like.

The data center 110 may include a server 112, data storage 114 and/or the like. The server 112 may be any type of computing device available in the market. The server 112 may be a single computing device or a combination of two or more computing devices. The server 112 may be located at the same location as the data storage 114 or may be located in a different location but connected to the data storage 114 via the communication channels 102. The data center 110 may be operated by a mobile survey management service provider. Alternatively, the data center 110 may be owned and/or operated independently by an organization, a company, a govern rent and/or the like. The data center 110 may be administered by one or more operators 116A and 116B. However, the data center 110 may be configured to automatically carry out the mobile survey management services without any input from the operators 116A and 116B. The data storage 114 may be connected to and managed and operated by the server 112. The storage 114 may be any type of data storage device available in the market. The storage 114 may be a single data storage device or a combination of two or more data storage devices that may be stored in the same or different locations. The data storage 114 may store a survey database containing various information related to mobile survey management, such as, e.g., surveyor information, surveyee information, survey question information, survey results information and/or the like, which are described in detail below.

The communication channels 102 may be any type of wired or wireless electronic communications network, such as, e.g., a wired/wireless local area network (LAN), a wired/wireless personal area network (PAN), a wired/wireless home area network (HAN), a wired/wireless wide area network (WAN), a campus network, a metropolitan network, an enterprise private network, a virtual private network (VPN), an internetwork, a backbone network (BBN), a global area network (GAN), the Internet, an intranet, an extranet, an overlay network, a cellular telephone network, a Personal Communications Service (PCS), the Global System for Mobile Communications (GSM) and/or the like, and/or a combination of two or more thereof. The management computers 120 and the mobile survey devices 130 may communicate with the data center 110 from anywhere and at anytime via the communication channels 102.

One or more survey managers 122, such as, e.g., the first survey manager 122A, the second survey manager 122B and/or the like, may access the data center 110 to manage a survey project using one or more management computers 120. For security and/or confidentiality reasons, access to the survey database may be limited to those with survey manager privileges. For example, only those with a valid login name and password may access the data center 110. The management computers 120 may be any type of computing devices, such as, e.g., a desktop computer 120A, a laptop/mobile computer 120B, a personal data assistant (PDA) (not shown), a mobile phone (not shown), a tablet computer (not shown) and the like, with wired/wireless communications capabilities via the communication channels 102. Using the management computers 120, the survey managers 122, such as, e.g., the first survey manager 122A using the desktop 120A, the second survey manager 122B using the laptop 120B and/or the like, may access the survey database to plan, create, modify and/or delete a survey project and to enter, modify and/or delete the various information related to mobile survey management.

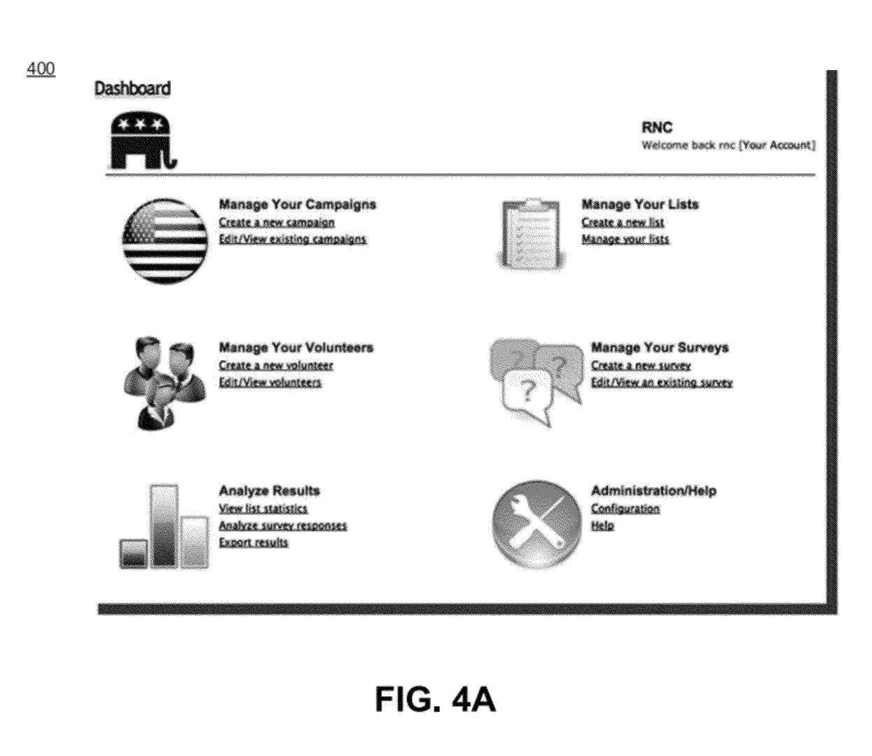

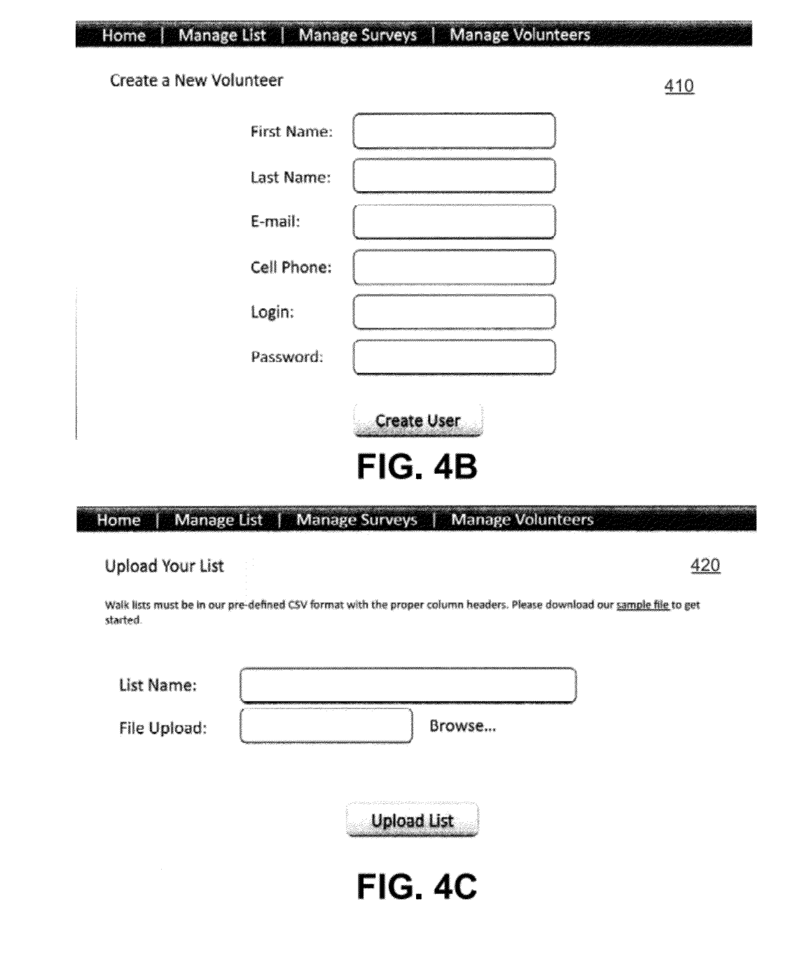

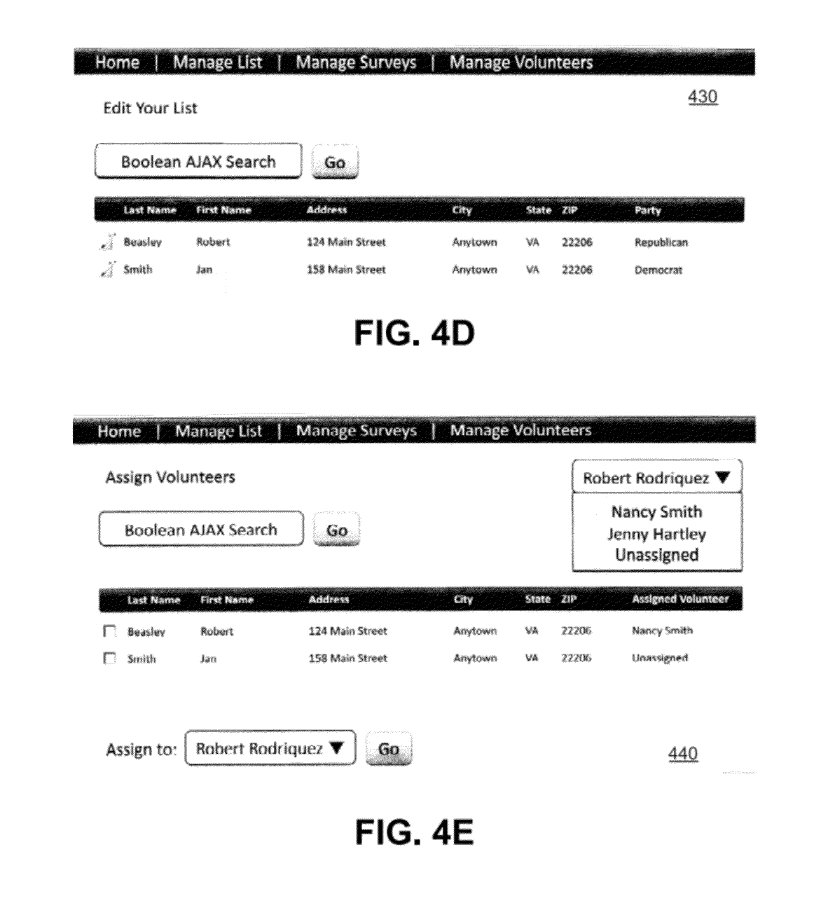

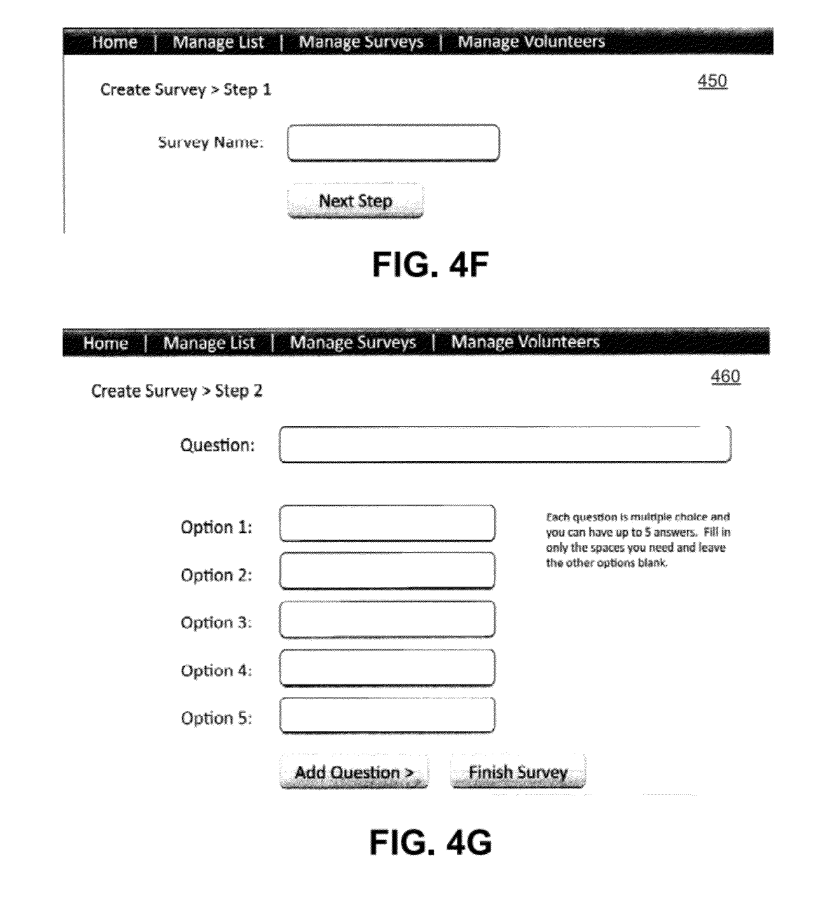

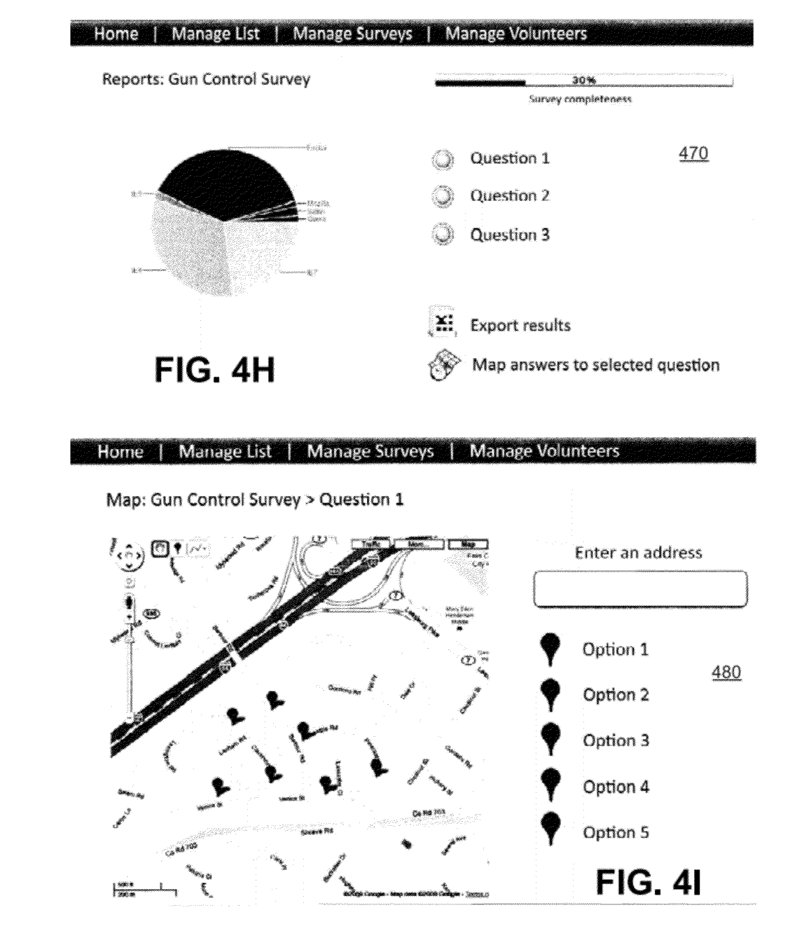

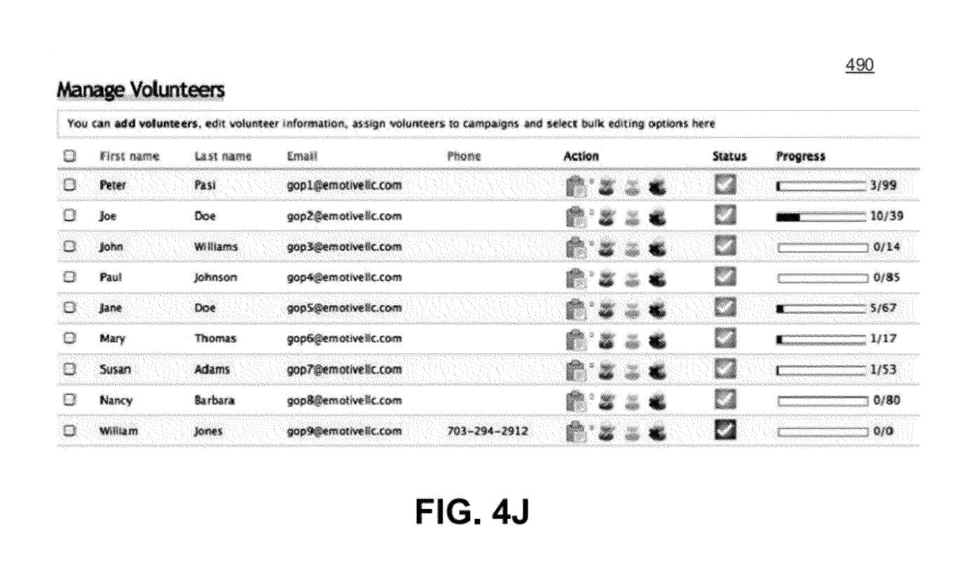

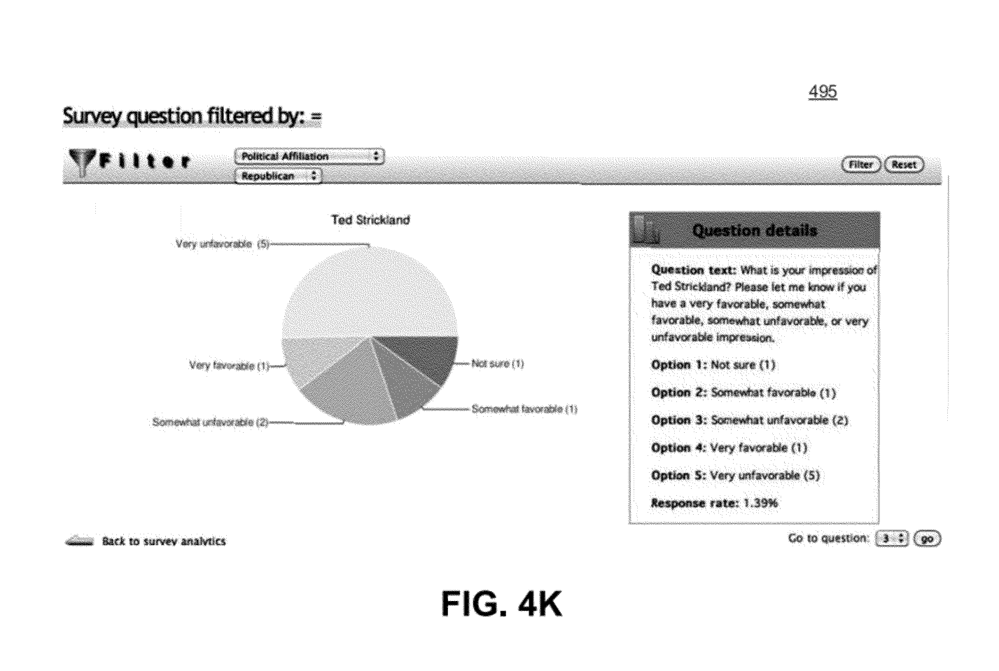

In an embodiment, the survey management may be web-based. For example, the server 112 may operate a web application to allow the survey managers 122 to access the data center 110 to operate the survey database by using the management computers 120 via the communication channels 102. The web application may be hosted in a browser-controlled environment (e.g., a Java applet and/or the like), coded in a browser-supported language (e.g., JavaScript combined with a browser-rendered markup language (e.g., Hyper Text Markup Language (HTML) and/or the like)) and/or the like such that any management computer 120 running a common web browser (e.g., Internet Explorer™, Firefox™, Chrome™ or the like) may render the application executable, for example, as shown in FIGS. 4A, 4B, 4C, 4D, 4E, 4F, 4G, 4H, 4I, 4J and 4K. Additionally or alternatively, client software may be installed in each of the management computers 120 locally in order to access the data center 110. However, a web-based service may be more beneficial due to the ubiquity of web browsers and the convenience of using a web browser as a client (i.e., thin client). Further, with inherent support for cross-platform compatibility, the web application may be maintained and updated without distributing and installing software on each management computer 120. Thus, the survey managers 122 may access the data center 110 and manage the survey database in the data storage 114 anytime using virtually any computer.

The plurality of mobile survey devices 130, such as, e.g., first survey device 130A, second survey device 130B, third survey device 1300 and/or the like, may be carried by a plurality of surveyors 132, such as, e.g., first surveyor 132A, second surveyor 132B, third surveyor 1320, and/or the like, respectively. The mobile survey devices 130 may be any type of mobile communication device, such as, e.g., a mobile phone, a mobile computer, a mobile tablet computer or the like. In an embodiment, the mobile survey devices 130 may be any type of mobile smartphones that are operated by any type of advanced mobile data processing and communication operating system, such as, e.g., an Apple™ iOS™ operating system, a Google™ Android™ operating system, a RIM™ Blackberry™ operating system, a Nokia™ Symbian™ operating system, a Microsoft™ Windows Mobile™ operating system, a Microsoft™ Windows Phone™ operating system, a Linux™ operating system or the like.

The smartphones, many of which may be already owned by the surveyors 132, may be easily transformed to the mobile survey devices 130 by simply downloading a mobile survey application for the phone's particular platform from one of many online application stores, a website operated by the data center 110, a third-party application developer's designated download site, and/or the like, which may be easily accessible using the phones' data communication capabilities. The mobile survey application may have an intuitive and easy-to-use graphical user interface. Upon installing the mobile survey application, the mobile smartphone may immediately receive a list of surveyees, survey information, a list of survey questions and/or the like from the data center 110. Thus, anyone with a smartphone may volunteer or be recruited as a surveyor, assigned a list of surveyees, provided with survey questions and quickly dispatched to a survey area.

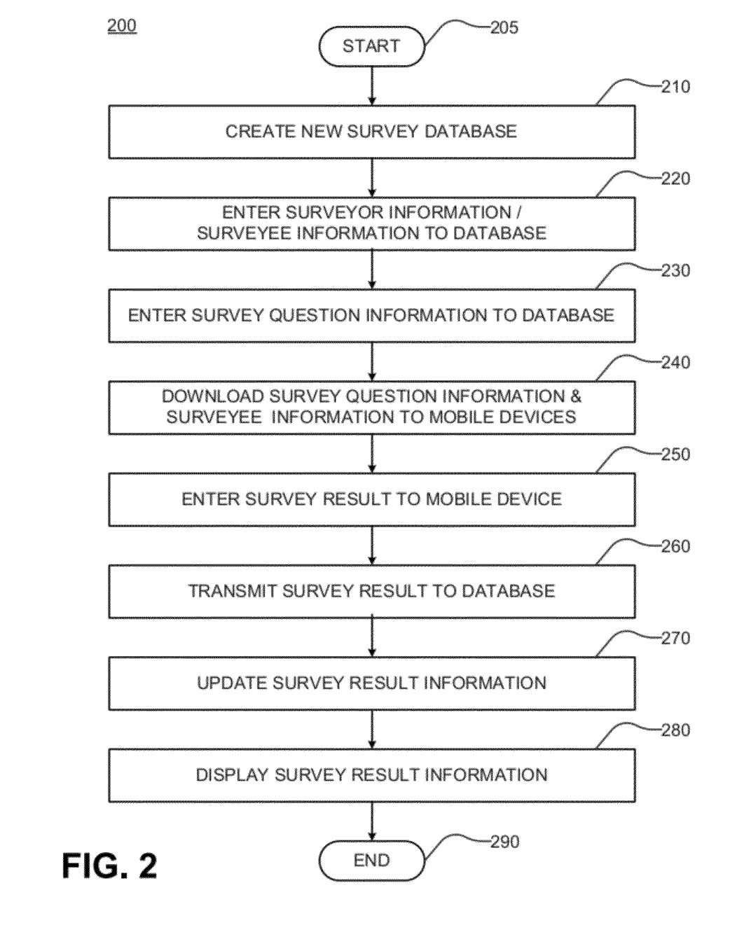

FIG. 2 shows a flowchart of a process 200 for mobile survey management according to the principles of the disclosure. Upon starting the process 200 (at 205), the survey manager 122 may access the data center 110 to create a new survey database (at 210). For example, FIG. 4A shows a dashboard webpage 400 of a mobile survey management website partic configured for an election campaign survey, constructed according to the principles of the disclosure. However, the mobile survey management may be configured for different purposes, such as, e.g., brand value survey, customer satisfaction survey, employee satisfaction survey, current population survey and/the like.

The dashboard webpage 400 may display a menu for various election campaign survey management categories, such as, e,g., “Manage Your Campaigns,” “Manage Your Lists,” “Manage Your Volunteers,” “Manage Your Surveys,” “Analyze Results,” “Administration/Help” and/or the like. By clicking a “Create a new campaign” link under the “Manage Your Campaign” category, the survey manager (or a campaign manager) 122 may create a new survey database for a particular election campaign, for example, a “John Smith for Senate” campaign. The campaign manager 122 i ay edit and view the survey database anytime by clicking a “Edit/View existing campaigns” under the “Manage Your Campaigns” category.

Once the new survey database is created (at 210), the campaign manger 122 may enter surveyor information and surveyee information to the survey database (at 220). For example, the campaign manager 122 may click a “Create a new volunteer” link under the “Manage Your Volunteers” category in the dashboard webpage 400 to create a new surveyor 132 for the campaign. The “Create a new volunteer” link may be linked to another webpage where the campaign manager 122 enters surveyor information, such as, e.g., a webpage 410 shown in FIG. 4B. The webpage 410 may include one or more drop-down lists, text boxes, check boxes and/or the like, for entering and/or selecting the surveyor information, such as, e.g., a surveyor's first name, last name, Email address, cellular phone number, login name, password and/or the like. By clicking a “Create User button at the bottom of the webpage 410, an account may be created for the surveyor 132. The surveyor 132 may be a volunteer for the election campaign, as indicated in FIG. 4B. Alternatively, the surveyor 132 may be a candidate himself or herself, a candidate's family member or friend, a campaign staff, a temporary hire for the campaign and/or the campaign survey, Once the surveyor account is created (at 220) and stored in the survey database, the surveyor 132 may download and install the mobile survey application to his or her smartphone 130 and enter his or her login name and password to run the mobile survey application.

The campaign manager 122 may then enter the surveyee information to the survey database (at 220). The surveyee information may include a list of people, a list of addresses, a list of entities (e.g., businesses, companies, organizations and the like) and/or the like. The surveyee information may be a list of addresses and/or voters in a district where the candidate is running for election. Alternatively, for a marketing survey, the surveyee information may include a list of current and/or potential customers in the U.S. or the entire world. For example, the campaign manager 122 may click a “Create a new list” link under the “Manage Your Lists” category in the dashboard webpage 400 to enter the surveyee information. The “Create a new list” link may be linked to another website where the campaign manager 122 may enter the list of surveyees, such as, e.g., on a webpage 420 shown in FIG. 4C. The campaign manager 122 may use a surveyee list file in spreadsheet format (e.g., Microsoft™ Excel™, IBM™ Lotus 1-2-3™, Apple™ Numbers™ and the like), a data serialization format (e,g., CSV, XML and the like) and/or the like, which may be uploaded from the management computer 120 to the survey database in the data storage 114 via the communication channels 102. The surveyee information may further include a person's age, sex, race, voting registration date, registered party, phone number and special notes,

Upon completing entering the surveyor information and surveyee information to the survey database (at 220), each surveyor 132 may be assigned to one or more surveyees. The server 112 at the data center 110 may automatically assign each surveyor 132 to one or more surveyees based on the surveyor information and the surveyee information stored in the database. For example, the server 112 may be configured to analyze and compare various factors of the surveyors 132 and the surveyees, such as, e.g., age, sex, race, religion, occupation, address, political affiliation and/or the like, to find a matching surveyor for each surveyee. Alternatively, the campaign manager 122 may assign a surveyor 132 to one or more surveyees. For example, the campaign manager 122 may search the surveyees in the survey database by, for example, clicking a “Manage your lists” link under the “Manage Your Lists” category in the dashboard website 400. The “Manage your lists” link may be linked to a website, such as, e.g., a website 430 shown in FIG. 4D, where the campaign manager 122 may conduct various searches (e.g., Boolean AJAX search and the like) to sort the surveyees by one or more categories, such as, e.g., age, sex, race, ethnicity, address, city, state, zip code, political affiliation and/or the like. The search result may include a list of surveyees as shown in FIG. 4D. As shown in FIG. 4E, the campaign manager 122 may manually select and assign one of the surveyors 132 to one of the surveyees in the list.

The campaign manager 122 may than click a “Create a new survey” link under the “Manage your surveys” category in the dashboard webpage 400, which may be linked to another webpage where the campaign manager 122 may enter survey question information (at 230). For example, FIGS. 4F shows a webpage 450 where the campaign manager 122 may enter a survey name, such as, e.g., “Gun Control Survey” or the like. Upon clicking a “Next Step” button at the bottom, another page a shown in FIG. 4G may be displayed, where the campaign manager 122 may enter a survey question and a number of options (or answers) for the survey question, which may be sent to the data center 110 and stored in the survey database as survey question information (at 230). To add another survey question, the survey manager 122 may click an “Add Question” button at the bottom of the page 460 as shown in FIG. 4G, which may be linked to another webpage similar to the page 460 for entering the second question and a number of options for the second question.

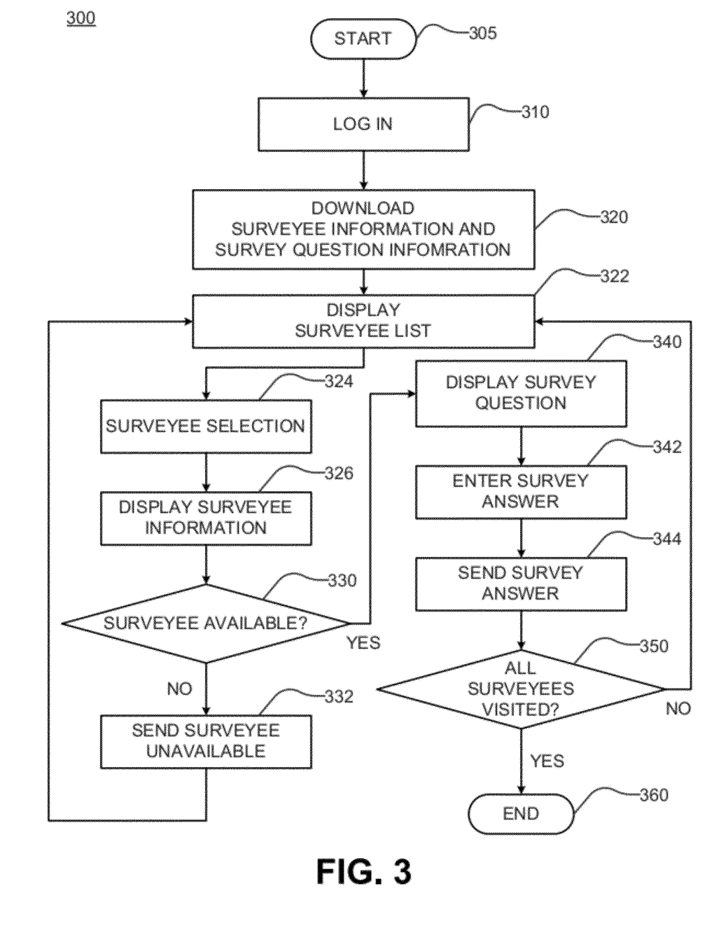

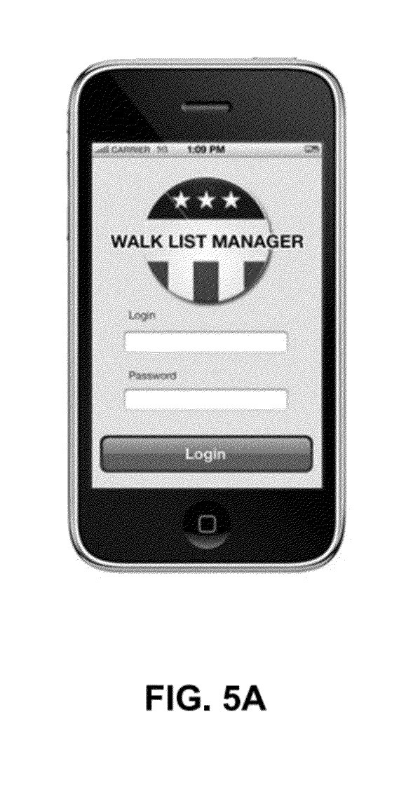

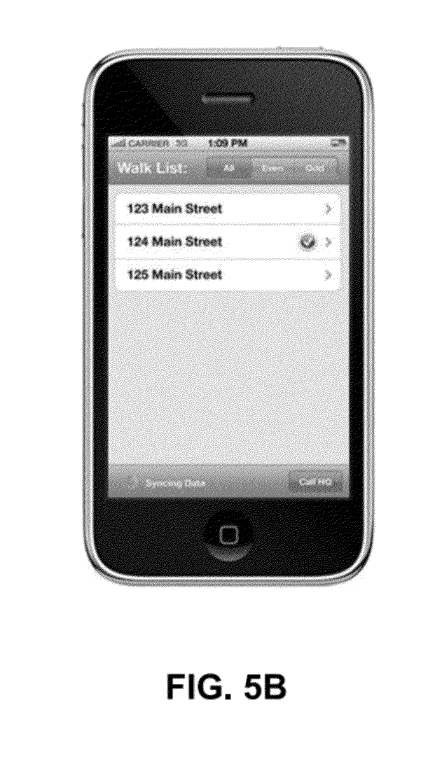

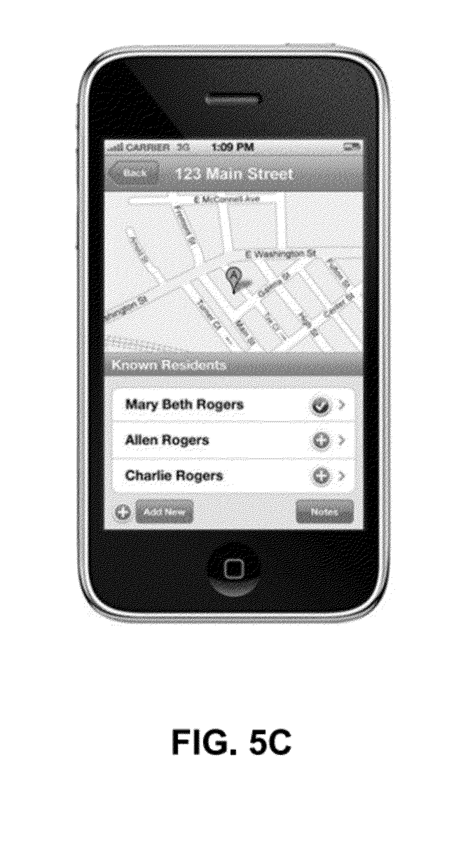

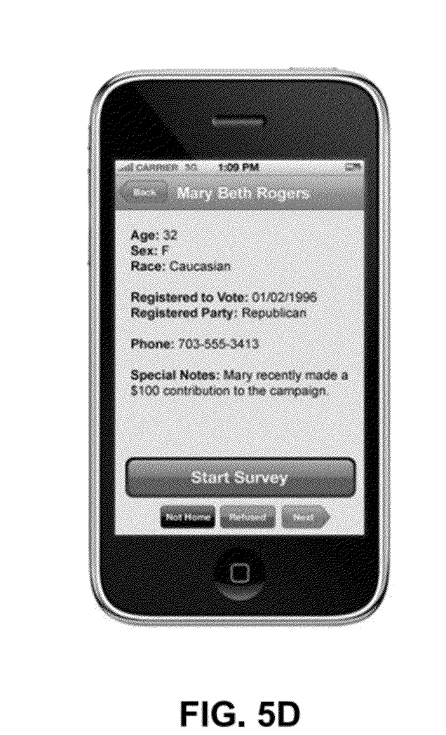

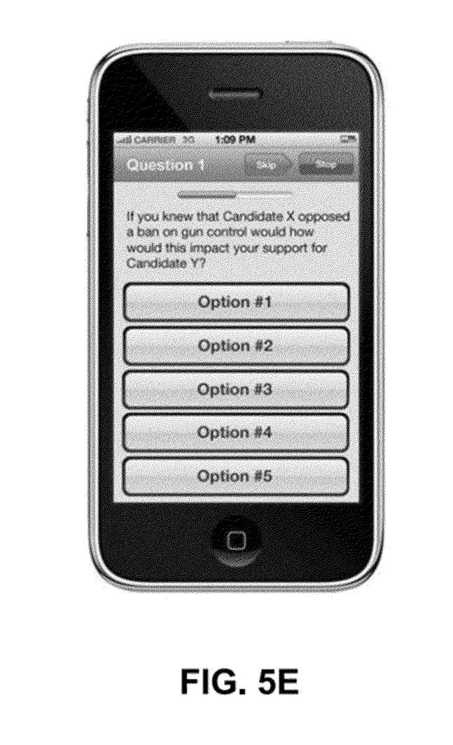

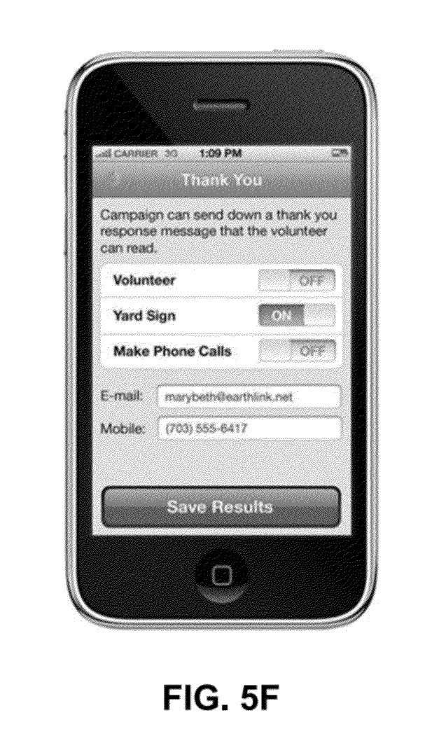

Once the surveyor information, the surveyee information and the survey questions are entered in the survey database, each surveyor 132 may conduct surveys on the surveyees assigned to her or him using her of his mobile survey device 130. For example, FIG. 3 shows a flowchart of a process 300 for operating the mobile survey device 130 according to the principles of the disclosure. First, upon starting the mobile survey application, a login screen may be displayed on the mobile survey device 130, as shown in FIG. 5A. The surveyor 132 may then enter her or his login name and password to run the mobile survey application on her or his m bile survey device 130 (at 310). After logging in, the mobile survey device 130 may download the surveyee information and the survey question information from the data center 110 (at 320). Then, the mobile survey device 130 may display a list of surveyees' addresses assigned to the surveyor 132 (at 322), as shown in FIG. 5B. Since the survey is a door-to-door survey, the surveyees assigned to her or him may be located in substantially the same geographical area. Sometimes two surveyors 132 may be paired and assigned the same list of surveyees. Optionally, the mobile survey application may have a function that allows each surveyor 132 to select the surveyees based on, e.g., street number (i.e., “Even” and “Odd”) and/or the like, as shown in FIG. 5B, such that each surveyor 132 may conduct the survey without overlapping with the other surveyor's surveying process. Furthermore, to help the surveyor 132 find the surveyees quickly, the mobile survey device 130 may display the locations of the surveyees assigned to her or him, as shown in FIG. 5G.

When the surveyor 132 selects one of the surveyees ov the list (at 324) to visit (at 326), the mobile survey device 130 may download and display the selected surveyee's information, such as, e.g., age, sex, race, voting registration date, registered party, phone number, special notes and/or the like, on the display, if such information is available in the survey database, as shown in FIG. 5D. Before visiting the surveyee, the surveyor 132 may study the surveyee information in preparation for conducting the survey. If the surveyee is not available (No at 330), the surveyor 132 may enter such information to her or his mobile survey device 130. Such information may be sent to the data center 110 and entered in the database in a real-time basis (at 332), and the mobile survey device 130 may display the surveyee list (at 322) for the surveyor 132 to select the next surveyee to visit.

When the surveyee is available to take the survey (Yes at 332), the mobile survey device 130 may display the survey question information, such as, e.g., one or more survey questions, a plurality of options (i.e., answers) that the surveyee can choose from and/or the like (at 340, also at 240 in FIG. 2), as shown in FIG. 5E. The surveyor 132 or the surveyee may enter the options selected by the surveyee to the mobile survey device 130 (at 342, also at 250 in FIG. 2) by, for example, tapping one of the option number buttons shown in FIG. 5E. Once the survey has concluded, the mobile survey device 130 may display a thank you message as shown in FIG. 5F. Furthermore, the surveyor 132 may enter additional information gathered from the surveyee to the mobile survey device 130, such as, whether or not the surveyee is willing to participate the campaign as a volunteer, whether or not the surveyee is willing to display a yard sign in her or his yard to support the campaign, whether or not the surveyee is willing to make phone calls to support the campaign and/or the like, as shown in FIG. 5F. Further, the surveyor 132 may enter the surveyee's email address and phone number. The surveyee's answers and additional information may be sent to the data center 110 in a real-time manner or stored in the mobile survey device 130 and later transferred to the data center 110 (at 344, also at 260 in FIG. 2). If the surveyors 132 have not visited all the surveyees in the list No at 350), the mobile survey device 130 may display the list of remaining surveyees to visit (at 322). Otherwise (Yes, at 350), the process 300 may terminate (at 360). The mobile survey application may be further configured to show whether each of the surveyees has completed the survey. For example, as shown in FIG. 5B, the mobile survey application may display a check sign next to the surveyee at 124 main street, indicating that the survey has been completed for that surveyee.

Referring back to FIG. 2, the survey database, particularly the survey results information, may be updated (at 270) in real-time based on the surveyees answers and, if available, the additional data transmitted from each mobile survey device 130. Then, the data center 110 may display the survey results information to the management computer 120 (at 280) and the process 200 may terminate (at 290).

The survey results information may be displayed in various formats on any management computer 120. For example, the survey results information may include a real-time overall survey completeness (e.g., 30%) by the surveyors 132, as shown in FIG. 4H. Also, as shown in FIG. 4J, the survey results information may include the progress of each surveyor 132 in completing its assigned surveys. Further, the survey results information may include a real-time pie-chart of the options (i.e., answers) selected by the surveyees, as shown in FIG. 4H. The survey results information may also be displayed as a map showing the surveyees' locations and options selected by each surveyee in different colors or symbols, as shown in FIG. 4I. Additionally, the survey results information may be filtered by any available variable, such as, e.g., sex, age, religion, race, political affiliation (e.g., republican, democrat, independent and the like, as shown FIG. 4K) and/or the like. Furthermore, nowadays most mobile smartphones have GPS capabilities to track each surveyor's current location. Thus, if the surveyor's current location does not match the surveyee's address, any information entered by the surveyor 132 at a mismatched location may be marked as a suspicious entry in the survey database. Furthermore, when a surveyor 132 generates too many suspicious entries, the survey manager 122 may warn the particular surveyor 132 or remove the surveyor 132 from her of his surveying duty.

While the disclosure has been described in terms of exemplary embodiments, those skilled in the art will recognize that the disclosure can be practiced with modifications in the spirit and scope of the appended claims. These examples given above are merely illustrative and are not meant to be an exhaustive list of all possible designs, embodiments, applications or modifications of the disclosure.

What is claimed is:

1. A method for mobile survey management, comprising:
creating a survey database for storing surveyee information, survey question information, survey results information, the surveyee information comprising a list of a plurality of surveyees to be visited by a plurality of surveyors, and the survey question information comprising a survey question to ask to the plurality of surveyees;
assigning one or more surveyors to one or more surveyees;
transmitting the surveyee information including the list of one or more surveyees assigned to each surveyor to each surveyor's mobile survey device along with the survey question information;
displaying the list of the one or more surveyees assigned to each surveyor on each surveyor's mobile survey device;
displaying the survey question on the display of each surveyor's mobile survey device;
entering an answer by each surveyee to the survey question to the mobile survey device;
transmitting survey result from each mobile survey device to the database, the survey result comprising the answer by each surveyee to the survey question; and
updating the survey results information in the survey database based on the survey results transmitted from the plurality of mobile survey devices in a real-time basis.

2. The method of claim 1, wherein the plurality of surveyees comprises at least one of a plurality of addresses, a plurality of people and a plurality of entities.

3. The method of claim 2, wherein the surveyee information further comprises at least one of a person's age, sex, race, voting registration date, registered party, phone number and special notes.

4. The method of claim 1, wherein the one or more surveyees in the list assigned to each surveyor are located in the same geographical area.

5. The method of claim 1, wherein the survey database stores surveyor information in the data storage, the surveyor information comprising a list of the plurality of surveyors.

6. The method of claim 5, wherein the surveyor information further comprises at least one of login information, a name, an email address and a phone number of each surveyor.

7. The method of claim 1, further comprising:
modifying the survey question stored in the survey database;
transmitting the modified survey question the plurality of mobile survey devices; and
replacing the survey question in each mobile survey device with the modified survey question on the display of each mobile survey device.

8. The method of claim 1, further comprising displaying a map showing locations of the one or more surveyees assigned to each surveyor on a display of each surveyor's mobile survey device.

9. The method of claim 1, further comprising displaying whether or not each surveyor's in the list answered the survey question.

10. The method of claim 1, further comprising displaying each surveyor's progress in surveying the one or more surveyees in the list assigned each surveyor.

11. A system for mobile survey management, comprising:
a data center comprising a survey database for storing surveyee information, survey question information, survey results info nation the surveyee information comprising a list of a plurality of surveyees to be visited by a plurality of surveyors, and the survey question information comprising a survey question to ask to the plurality of surveyees; and
a plurality of mobile survey devices connected to the data center via one or more communication channels and carried by the plurality of surveyors, respectively, each mobile survey device comprising:
a communication unit configured to receive the surveyee information including a list of one or more surveyees assigned to each surveyor along with the survey question information from the data center;
a display configured to display the list of the one or more surveyees assigned to each surveyor and the survey question information; and
a user interface configured to enter an answer by each surveyee to the survey question,
wherein the communication unit transmits each surveyor's answer to the survey question to the data center, and the survey results information in the survey database is updated based on each surveyee's answer transmitted from each mobile service device.

12. The system of claim 1, wherein each mobile survey device is one of a mobile phone, a mobile computer, a mobile tablet computer.

13. The system of claim 12, wherein each mobile survey device is a mobile phone operated by one of an Apple™ iOS™ operating system, a Google™ Android™ operating system, a RIM™ Blackberry™ operating system, a Nokia™ Symbian™ operating system, a Microsoft™ Windows Mobile™ operating system, a Microsoft™ Windows Phone™ operating system and a Linux™ operating system.

14. The system of claim 11, wherein the mobile survey device is further configured to display a map showing locations of the one or more surveyees in the assigned list on the display thereof.

15. The system of claim 11, wherein the mobile survey device is further configured to display whether or not each surveyee's in the assigned list has answered to the survey question on the display thereof in a real-time basis.

16. The system of claim 11, wherein the one or more surveyees in the list assigned to each surveyor are located in the same geographical area.

17. The system of claim 11, wherein the plurality of surveyees comprises at least one of a plurality of addresses, a plurality of people and a plurality of entities.

18. The system of claim 11, wherein the survey database further stores surveyor information comprising a list of a plurality of surveyors, the surveyor information further comprising at least one of each surveyor's login information, name, email address and phone number.

19. The system of claim 11, further comprising a management computer connected to the data center via the one or more communication channels to access the survey database.

20. The system of claim 19, wherein the management computer is configured to change the surveyee information and the survey question information and access the survey results information.
